(19) United States
(12) Patent Application Publication
(10) Pub. No.: US 2022/0161417 A1
(43) Pub. Date: May 26, 2022

(54) A CONFIGURABLE ROBOTIC PROCESSING SYSTEM

(71) Applicant: KARAKURI LTD., London (GB)

(72) Inventors: Simon WATT, London (GB); Barnaby William WRAGG, London (GB); Joe MULLER, London (GB); Samuel BROWN, London (GB)

(21) Appl. No.: 17/440,964

(22) PCT Filed: Mar. 16, 2020
(86) PCT No.: PCT/GB2020/050664

§ 371 Date: Sep. 20, 2021

(30) Foreign Application Priority Data
Mar. 19, 2019 (GB) 1903717.5

(51) Int. Cl. B25J 9/00; B25J 5/02; B25J 9/02; B25J 11/00; B25J 9/08

(52) U.S. Cl. CPC B25J 9/0084; B25J 5/02; B25J 9/08; B25J 11/0045; B25J 9/023

(57) ABSTRACT

Broadly speaking, embodiments of the present techniques provide a configurable robotic processing system in which the sequence of operations performed by the system may vary (in contrast to a conveyor-based system) and may be dynamically-scheduled.

The present techniques generally relate to systems and methods for automated processing of operations, and in particular relate to a configurable robotic processing system in which multiple operations may be performed in parallel to achieve high throughput. The systems and related methods may be particularly suited for food preparation, or for the assembly of individual meals/food products for users.

Typical automated processing systems automate some or all of the steps in a particular process, to enable a more uniform or consistent output and a higher throughput than a manual process. For example, a food production system may automate the process to make a lasagne. In this case, the output of the food production system is always identical: a lasagne with the same ingredients, which are assembled in the same way. The food production system typically comprises a conveyor belt which moves through different processing stations at a fixed speed and in a fixed order. Such a system is unable to produce lasagne which are customised for consumers specific requirements (e.g. with extra cheese, a different number of layers, extra fillings, etc.)

The present applicant has identified the need for a robotic processing system which is configurable to vary the speed of the output to match demand and to produce different, individually customised outputs.

In a first approach of the present techniques, there is provided a configurable robotic processing system comprising: a plurality of stations operable in parallel, each station performing an operation; at least one robot capable of selectively engaging, disengaging and moving containers to and from the plurality of stations; a communication module to receive a plurality of user requests, each user request indicating at least one operation to be performed, where the user requests are the same or different; a controller comprising at least one processor, coupled to the communication module and the at least one robot, to control the at least one robot to: determine a process schedule for the at least one robot to process the received plurality of user requests; and control, using the determined process schedule, the at least one robot to: collect a first container from at least one container collection area for a first user request; move the first container to a first station of the plurality of stations for a first operation to be performed; and move the first container, responsive to the determined process schedule, to one or more further stations until the first user request is complete.

In a second approach of the present techniques, there is provided a method of controlling a configurable robotic processing system comprising a plurality of stations operable in parallel, each station performing an operation, and at least one robot capable of selectively engaging, disengaging and moving containers to and from the plurality of stations, the method comprising: receiving a plurality of user requests, each user request indicating at least one operation to be performed, where the user requests are the same or different; determining a process schedule for the at least one robot to process the received plurality of user requests; and controlling, using the determined process schedule, the at least one robot to: collect a first container from at least one container collection area for a first user request; move the first container to a first station of the plurality of stations for a first operation to be performed; and move the first container, responsive to the determined process schedule, to one or more further stations until the first user request is complete.

In a related approach of the present techniques, there is provided a non-transitory data carrier carrying processor control code to implement any of the methods, processes and techniques described herein.

Preferred features are set out below and apply equally to each approach of the present techniques.

In each approach of the present techniques, each individual container corresponds to an individual user request. For example, each container within the system may be used to fulfil an individual user's request for a particular meal that may be composed of multiple different food items. This is in contrast to other robotic systems where containers are used to bulk prepare food items (e.g. to bulk cook French fries or fried chicken) that may then be used for multiple users/customers, or where containers are used to bulk store and dispense one type of item (e.g. only screws, or bolts, or nuts, or nails, etc.)

The system may dynamically determine the process schedule based on the received plurality of user requests, and then controls the robot(s) to move containers corresponding to each user request through the system in any order to fulfil each user request. That is, a first container may be collected from the container collection area to fulfil the first user request in the process schedule. The first user request in the process schedule may not necessarily be the first user request to be received by the system—the order of requests in the process schedule may depend on a number of factors. The system may collect a second container to fulfil the second user request in the process schedule while the first container is still moving through the system. That is, the system may achieve high throughput by collecting and moving multiple containers through the system at the same time, in an order that is defined by the process schedule.

As explained in more detail below, the containers may be provided by an operator/owner of the system, or may be input into the system by a user. For example, if the system is used within a particular restaurant, the restaurant owner may have their own containers that are used to fulfil user requests. The containers which are moved through the system may be takeaway containers that can be given to the users once their requests are fulfilled, or may be containers that are merely used to collect the various items for each user request and the contents of the containers are deposited into other containers (e.g. users' own containers) that are given to the users. In some cases, the system may use a container provided by an operator/owner of the system when a user does not provide their own container.

When the first user request is complete, the first container may be moved to a request collection area. The first container may then be collected by the associated user from the request collection area (or by an operator who passes the container, directly or indirectly, to the associated user. For example, an operator may provide the container to a waiter/waitstaff who passes the container to the associated user).

An advantage of the present techniques is that multiple user requests may be processed simultaneously. The sequence of operations performed by the system may be chosen to enable multiple user requests to be processed at the same time, taking advantage of the differences in the user requests. This may enable a high throughput to be achieved. The throughput may not be limited by the speed of any station, and it may be possible for the throughput of the system to be faster than the speed of any given station. For example, it may be possible to complete a request every 10 seconds even if the stations taken on average 20 seconds to perform their operations. This is because the stations are operating in parallel, so provided sufficient station capacity is provided for the statistics of the orders, the throughput may be maintained. The throughput may also be maintained while slower operations are being performed for some requests, as faster operations may be performed for other requests, ensuring that there is no delay in the system when a complex request or a complex/time-consuming operation is being performed. The stations may complete their operations in different times to enable this, which is not possible in typical conveyor-belt based robotic processing systems. The stations may not need to complete their operations in a known or pre-defined time—the system may be able to accommodate variable operation durations. The overall latency (processing time) of a particular request is determined by the complexity of the request, rather than the complexity of any other requests being processed by the system at the same time. Therefore, complex requests should not slow down simpler requests that are being processed simultaneously.

To process multiple requests simultaneously, the controller may be further configured to: collect, while the first operation or a subsequent operation is being performed for the first user request, another container from the container collection area for at least a second user request; move the container to another station of the plurality of stations; and continue moving the first container, second container and any further containers, responsive to the determined process schedule, to one or more further stations until each user request is complete. It will be understood that depending on how long the first operation takes, it may be more efficient for the robot to collect one or more new containers from the container collection (or partly-complete containers from other stations) during a subsequent operation being performed with respect to the first user request. The controller may take into account such timings to determine the process schedule being applied. Nevertheless, it is clear that at any given time, the at least one robot may be moving multiple containers through the system. This is advantageous because it is not necessary to complete a request before beginning the next request, which may enable a high throughput to be achieved.

Furthermore, even if two requests are identical, it may not be necessary to move the containers for both requests to the same stations or to process the two requests in the same order. This means that two identical requests, or requests which require common operations, may be performed simultaneously by determining an appropriate process schedule.

One way a high throughput may be achieved, particularly in the case where multiple requests may be identical or multiple requests require common operations to be performed, is by providing a system which comprises multiple versions of the same type of station. For example, in a food processing system, there may be more than one salad tossing station or more than one high value protein pick and place station. This may enable the multiple operations of the same time to be performed simultaneously. Having multiple stations of the same type may also enable stations to be refilled while the system is running without impacting the throughput of the system.

Determining a process schedule for the at least one robot may comprise applying a pre-determined process schedule. In this case, the controller may simply retrieve a stored, pre-determined process schedule and apply the retrieved process schedule. Multiple pre-determined process schedules may be stored, and the controller may select the most appropriate process schedule based on the received user requests.

Additionally or alternatively, determining a process schedule for the at least one robot may comprise dynamically determining the process schedule based on at least the received plurality of user requests. That is, the process schedule may not be determined in advance but may be determined in real-time or near real-time or on-the-fly in response to the received requests. A process schedule may be dynamically determined for a given set of received requests and a different process schedule may be determined for the subsequent set of received requests. The process schedule may also be dynamically determined based on information received from the system, e.g. from individual stations. For example, if a particular station has stopped functioning, or if a station has run out of items to dispense, then the controller may take this information into account to avoid containers being moved to stations that cannot complete their operations. In some cases, dynamically determining the process schedule may also be based on the time taken for each operation.

The controller may determine, using the received user request, an order in which a container needs to be moved to the at least one station, and may control the at least one robot to move the container to the at least one station in the determined order.

The controller may: determine, for each received user request, the operation to be performed by a station; determine a required position in the container where the operation is to be performed; and control the at least one robot to position the container at the station to enable the operation to be performed in the required position in the container. For example, a station may need to deposit an item or set of items into the container, and the item(s) may need to be deposited into a particular area in the container (e.g. in a specific compartment in a tray or at a specific position on a plate). To enable this the container will be placed with a suitable positioning under the dispenser, such that it dispenses into the appropriate position within the tray. Similarly, a station may need to perform an operation at a specific position in the container (e.g. apply a flame to cook a food item placed in a particular part of the container, but not apply the flame to anything else in the container). Thus, the at least one robot may be controlled to position the container at the station in a particular way, positioning, offset or orientation.

In embodiments, the system may use a pre-determined process schedule at one given time, and a dynamically determined process schedule at another time. For example, when the system is in high demand (which for a food processing system may be at lunchtime), a dynamically determined process schedule may be advantageous as a high throughput is required. However, when the system is in less demand, a pre-determined process schedule.

Dynamically determining the process schedule may comprise using at least one of the following pieces of information/data: the operations required to complete each of the received user requests, a time taken to complete each of the received user requests, a time taken to complete each operation, an order in which the user requests are received, a number of user requests received in a time period, a status of each station (e.g. busy, not busy, needs refilling, not operational, etc.), ordering information on which operations need to be performed before or after other operations for each request (e.g. a salad needs to be added to a container before a salad dressing is added, mashed potato is added to a container and protein is placed on top of the mashed potato, etc.), and a delivery time for each received user request. It will be understood that this is a non-exhaustive list of data that may be used by the system.

As mentioned above, a time taken to complete the operation at each station may be the same or different, either inherently/by default, or each time the operation is performed/the station is used. In other words, the time taken to complete the operation at each station may be non-deterministic.

As mentioned above, a container may remain at a station until the operation performed by the station is complete and until the determined process schedule causes the at least one robot to return and collect the container. In other words, the at least one robot does not need to return and collect the container from a station as soon as the operation performed by the station is complete. In some cases, it may be advantageous for the container to remain at the station to enable the at least one robot to move other containers around the system. For example, a container may need to remain at the station until another station required for the request associated with the container becomes available, or until the at least one robot has completed another sequence of moves for one or more further containers.

The at least one robot may be any one of: a robotic arm, a cartesian coordinate robot, and a collaborative robot or cobot. It will be understood this is a non-exhaustive list. A cobot may be advantageous in some systems in which users may also interact with aspects of the system. For example, in a food processing system, users may need to refill stations of the system with more food items while the system is in use. Cobots may make the system safer for use without needing guarding requirements (e.g. barriers or safety screens) that make it difficult for a user to refill the stations, or for the system to shut down whilst the refilling operation is happening.

In some embodiments, the at least one robot of the system may comprise two or more robots. The number of robots in the system may depend on the throughput requirements of the system. Generally speaking, the more robots there are, the more containers may be moved through the system at once, and the more requests may be completed in a given time period, up to the limit imposed by the capacity of the stations. In embodiments, a single system may be used by two separate entities/operators/users. For example, a single system may be used to prepare food for two different restaurants/kitchens or two different airlines. In this case, each robot may be configured to process the orders relating to a specific entity.

Where the system comprises multiple robots, each robot may be assigned to a subset of the plurality of stations. The subsets may at least partly overlap. Dividing the stations into subsets that are assigned to each robot may help to avoid collisions between the robots. While allowing the subsets to partly overlap may mean that the robots can access more stations which may enable a higher throughput to be achieved than if the robots were restricted to their own specific stations and may allow for containers to efficiently move between the different subsets. The stations in the overlap which are shared by the robots may contain stations which perform popular operations to ensure that the containers can be passed between the robots without requiring a wasted move operation. In the overlap area, a robot may need to request access to a station in the overlap to avoid collisions/conflicts.

In embodiments, the plurality of stations, the container collection area and a request collection area (where the containers for completed requests are deposited) may be arranged in a cylindrical, part-cylindrical, curved or partly-curved array structure having one or more tiers. In this case, the at least one robot may be a robotic arm located along, and rotatable about, the cylindrical axis. Alternatively, the at least one robot may comprise a first robotic arm located at a top of the cylindrical array structure that is assigned to a first subset of the plurality of stations, and a second robotic arm located at a bottom of the cylindrical array structure that is assigned to a second subset of the plurality of stations. The subsets may at least partly overlap, as explained above.

In other embodiments, the plurality of stations, the container collection area and a request collection area may be arranged in a two-dimensional plane. In this case, at least one track may be provided over the plurality of stations, the container collection area and the request collection area, and the at least one robot may be a cartesian coordinate robot coupled to and arranged to move along the at least one track. The at least one track may be a vertical track or a horizontal track. The system may comprise multiple vertical tracks, multiple horizontal tracks, or a combination of vertical and horizontal tracks. The at least one robot may comprise a first cartesian coordinate robot assigned to a first subset of the plurality of stations, and a second cartesian coordinate robot assigned to a second subset of the plurality of stations. The subsets may at least partly overlap, as explained above.

In any case, the system may be modular, and the modular components may be moveable to enable the system to be cleaned or accessed by users, or reconfigured between different requirements. In the case of food processing, this might be to accommodate menu changes, or to accommodate applications with different food types.

Generally, when the at least one robot moves a container to a station, the controller instructs the station to perform its operation based on the received user request. The types of operations performed by the stations may depend on the type of processing performed by the system.

The step to determine a process schedule for the at least one robot may comprise: determining, using the received user request, an order in which a container needs to be moved to the at least one station. As mentioned above, this may be determined for each received user request by retrieving and applying a pre-defined order (from a set of pre-defined orders), or by dynamically determining the order based on other factors, such as the other requests being processed by the system at the time.

The system may further comprise at least one request collection area. The controller may control the at least one robot to deposit the first container (or contents of the first container) in the at least one request collection area when the first user request is complete. An operator of the system can collect a completed order/request from the at least one request collection area and provide it to a user, or user can collect their completed order/request themselves.

When the first container has been deposited in the at least one request collection area, the controller may control the communication module to output a message or alert indicating that the first user request is complete. The message/alert may be output to an operator of the system or to a user directly, using any suitable communication mechanism, so that the completed request can be collected from the request collection area. The message/alert may contain information about where in the request collection area the completed request is located (e.g. “in box A1” or “in area B2”). When the system has multiple request collection areas, the message/alert may specify in which request collection area the completed request is location (e.g. “in request collection area 1”).

The system may be a food preparation system, or a mechanical parts selection and packaging system. It will be understood that these are merely two example uses of the system described herein.

As will be appreciated by one skilled in the art, the present techniques may be embodied as a system, method or computer program product. Accordingly, present techniques may take the form of an entirely hardware embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be implemented using multiple processors or control circuits. The present techniques may be adapted to run on, or integrated into, the operating system of an apparatus.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

Implementations of the present techniques will now be described, by way of example only, with reference to the accompanying drawings, in which:

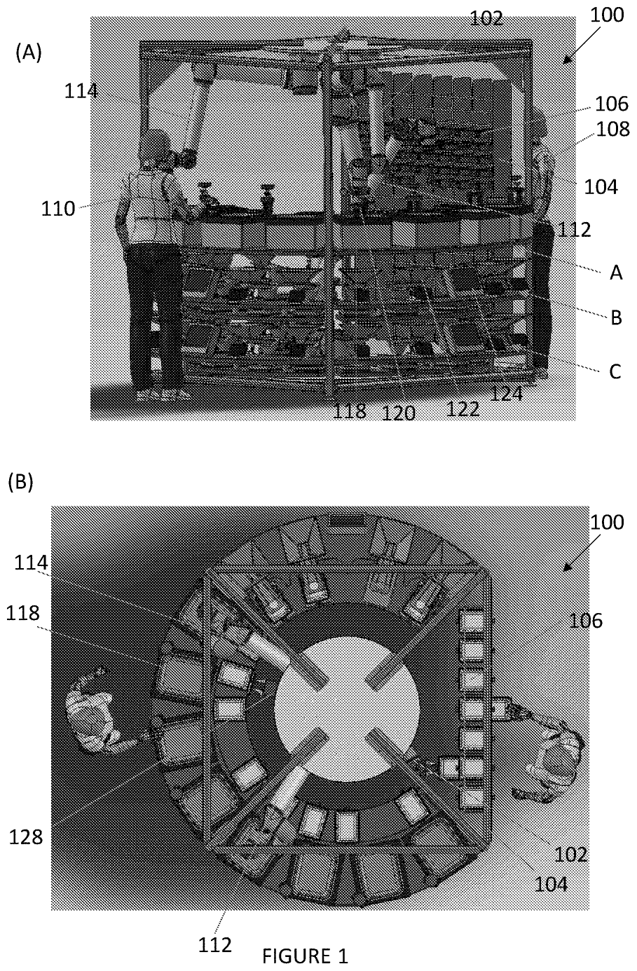

FIGS. 1A and 1B respectively show a perspective view and a plan view of an example configurable robotic processing system arranged in a cylindrical array structure;

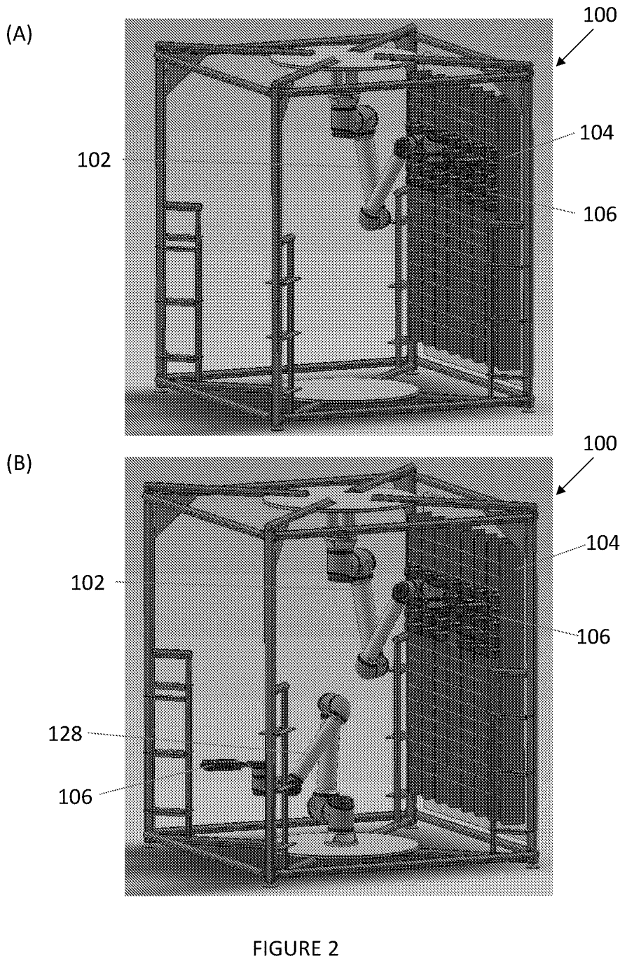

FIG. 2A shows a perspective view of a configurable robotic processing system having a single robotic arm;

FIG. 2B shows a perspective view of a configurable robotic processing system having two robotic arms;

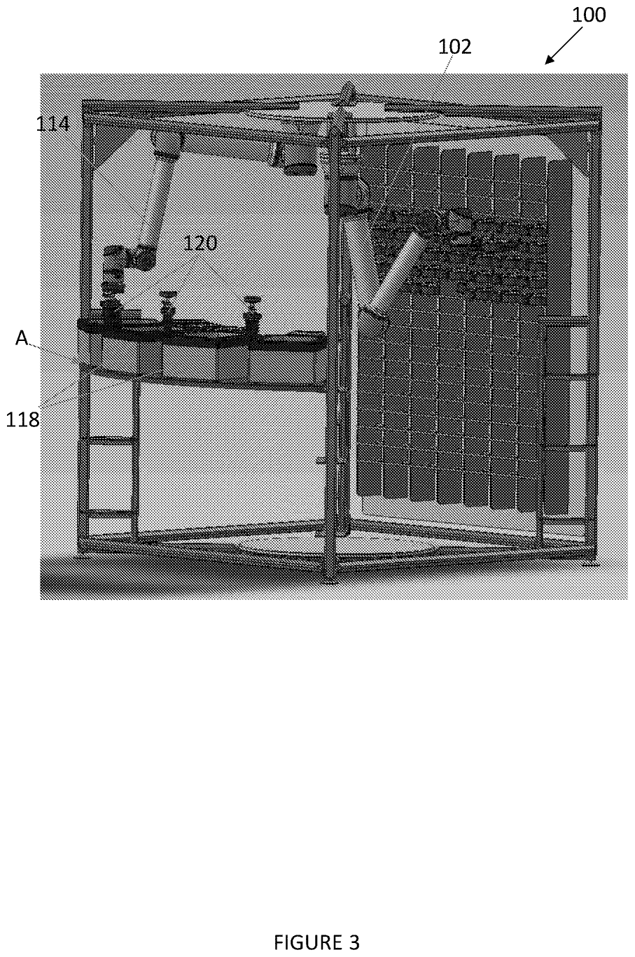

FIG. 3 shows a perspective view of a configurable robotic processing system having pick-and-place stations;

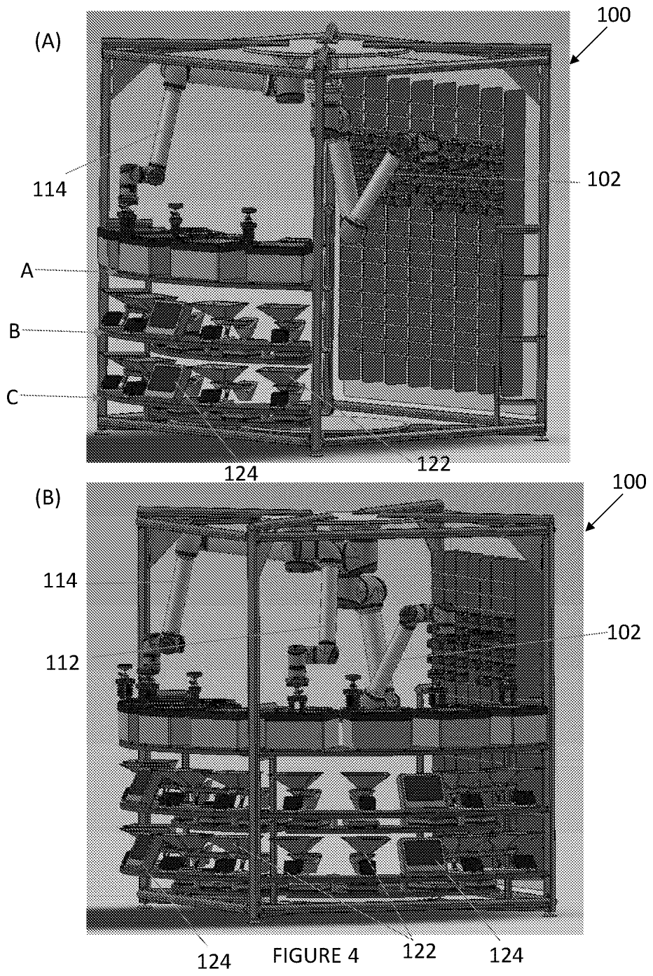

FIGS. 4A and 4B show perspective views of a configurable robotic processing system having pick-and-place stations and dispense stations;

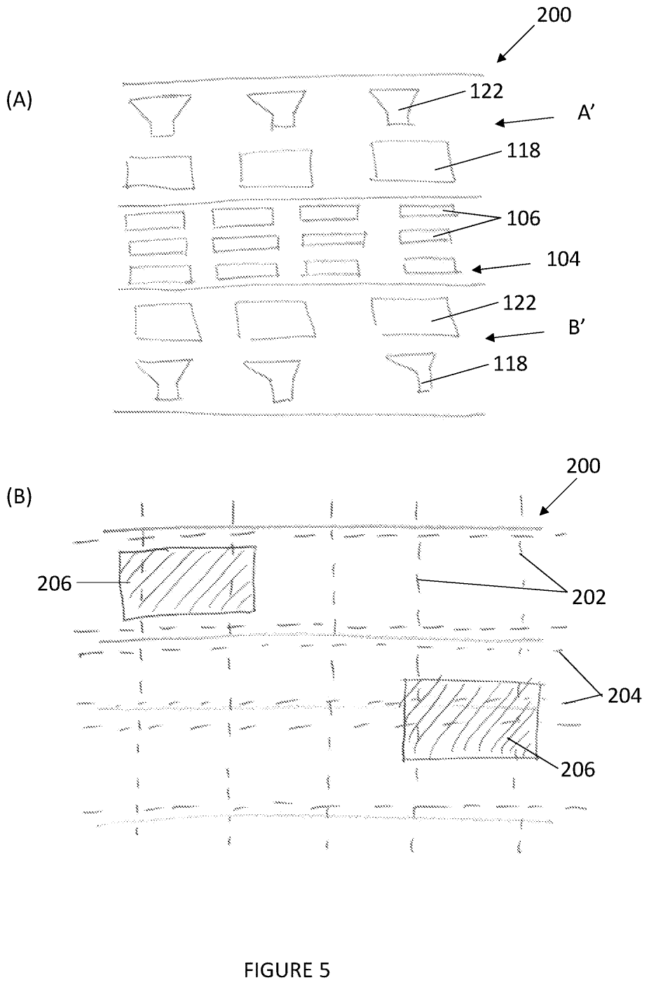

FIG. 5A shows a side view of an example configurable robotic processing system arranged in a two-dimensional plane;

FIG. 5B shows a side view of the system of FIG. 5A with tracks and two cartesian coordinate robots arranged to move along the tracks;

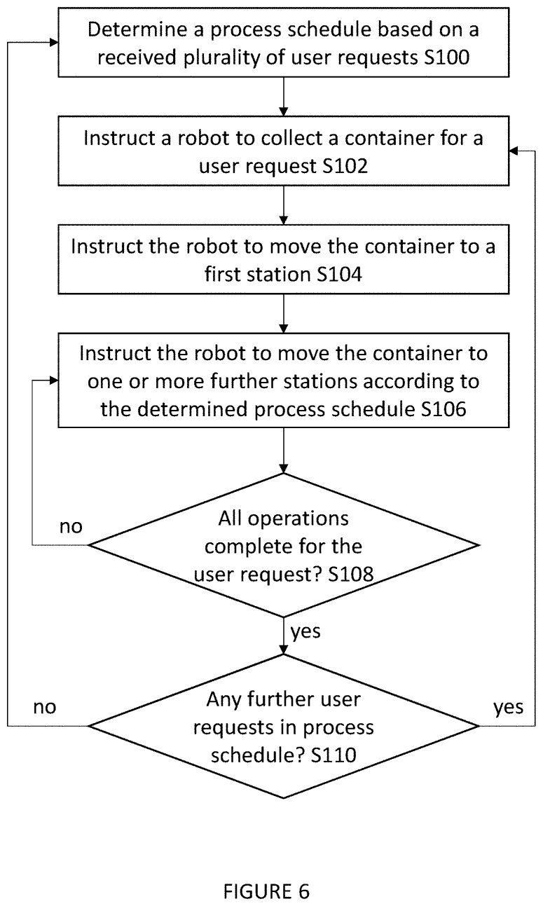

FIG. 6 shows a flowchart of example steps to control at least one robot to process a request received by a robotic processing system; and

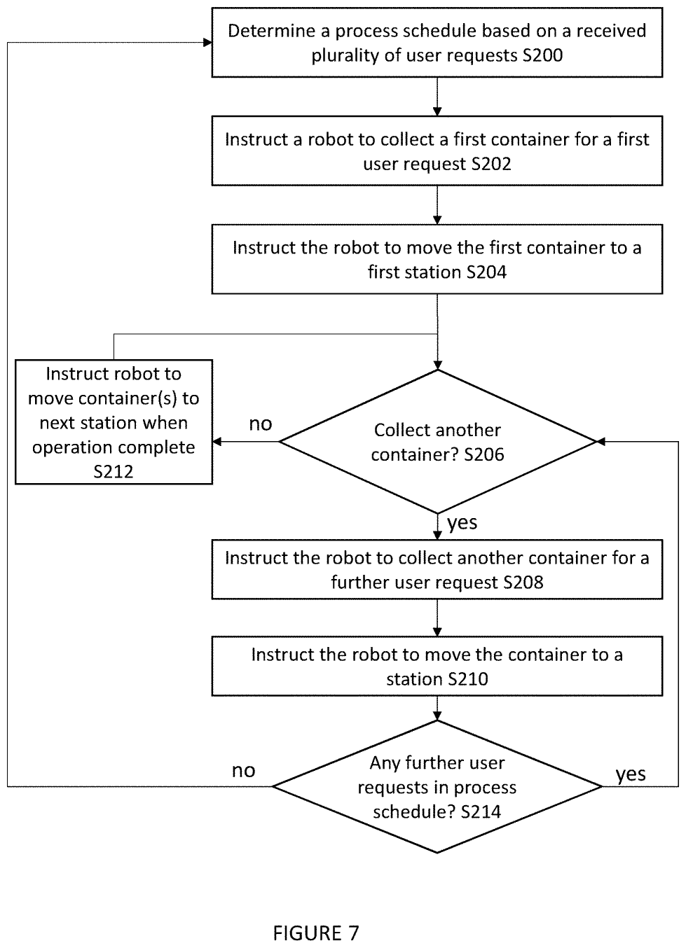

FIG. 7 shows a flowchart of example steps to control at least one robot to process, in parallel, multiple requests received by a robotic processing system.

Broadly speaking, embodiments of the present techniques provide a configurable robotic processing system in which the sequence of operations performed by the system and the timing of those operations may vary (in contrast to a conveyor-based system) and may be dynamically-scheduled.

The structure and features/components of the robotic processing system may vary depending on the type of processing being conducted by the system, and where the system may be used/installed. For example, the robotic processing system may need to fit into a restaurant, and therefore the dimensions may be chosen to suit the restaurant and the components may be chosen in accordance with the food that the restaurant produces and the number of orders which may need to be processed during a busy time in the restaurant.

To aid understanding of the configurable robotic processing system, two example configurations are shown in FIGS. 1A to 5B. Specifically, FIGS. 1A to 4 show a configurable robotic processing system arranged in a cylindrical array structure, while FIGS. 5A to 5B show a configurable robotic processing system arranged in a two-dimensional plane. However, it will be understood that these are merely illustrative examples and are non-limiting.

FIGS. 1A and 1B respectively show a perspective view and a plan view of an example configurable robotic processing system 100 arranged in a cylindrical array structure.

The system 100 comprises a plurality of stations which may be operable in parallel, where each station performs a particular operation. The station types may depend on the processing performed by the system 100. For example, a station 100 which is arranged to prepare food (e.g. in a restaurant, for a food delivery service, for airplane meals, etc.) may have stations which perform a food dispensing operation. In this case, a station may be, for example, a:
Weigher/weighing scale/linear weigher—for weighing and dispensing specific quantities of solid food products (e.g. 50 g of shredded lettuce);
Linear counter;
Conveyor;
Retractable conveyor; and
Pick-and-place mechanism—for picking up items (e.g. boiled eggs, slices of beef, pre-packed containers of sauce, etc.) and placing them onto a receptacle (e.g. a plate or food container).

A system 100 which is arranged to prepare food may comprise stations which perform a food preparation operation, such as:
Grilling;
Cooking;
Mixing;
Tossing (e.g. tossing salad ingredients); and
Inspection.

In a system 100 which is arranged to prepare food, some stations may be used to temporarily hold or store food. Such stations may be temperature controlled. For example, if the system has prepared a hot meal, the completed meal may be placed in a temporary storage station which comprises a heating mechanism to keep the meal hot until it is collected.

In another example, the system 100 may be a mechanical parts selection and packaging system. A user may request specific mechanical parts (e.g. nuts, bolts, screws, washers, etc.) for something they are constructing, and the system 100 may provide them with a package containing the requested mechanical parts. The package may comprise multiple compartments into which each type of mechanical part may be placed by the system 100. In this system 100, each station may be arranged to dispense a particular part in a required quantity. The system 100 may comprise additional stations which perform other types of operation, such as:
Inspection;
Sealing the package/tray to enable it to be shipped to or collected by the user; and
Printing and applying a label to the package to indicate the order number, contents, etc.
   It will be understood that these inspection, sealing, collection and label printing and applying stations may be provided in other systems 100, such as food preparation or food delivery systems.

Merely to aid understanding of the present techniques, FIGS. 1A to 5B are described by assuming the system is arranged for food preparation. However, it will be understood that food preparation is merely one of many possible uses of the present techniques.

Turning back to FIG. 1A, a number of different stations are illustrated, and it will be understood that both the quantity and types of station are exemplary and non-limiting. The stations may be arranged in a cylindrical or part cylindrical or curved array structure. It can be seen in FIGS. 1A and 1B that the system 100 comprises a curved section/edge and a straight section/edge. The stations may be arranged along the curved section/edge. The system 100 may comprise a container collection area 104, which may hold a plurality of containers 106. The container collection area 104 may be located along the straight section/edge of the system 100. The containers 106 are used by the system 100 to fulfil received user requests, and the form of these containers may vary depending on the process being performed by system 100. The term “container” is used herein to generally mean any receptacle suitable for the processing performed by the system 100, such as a tray, a plate, a package, a compartment tray, a vessel, a bottle, a cup or glass, a jar, a drinks or liquid container, a box, a carton, a packet, etc. It will be understood that this is a non-exhaustive list of example containers, and is non-limiting.

The containers 106 may be provided by an operator/owner of the system, or may be input into the system by a user making a request. For example, the containers 106 may be:
provided in the system by an owner/operator of the system, and when they have been used to fulfil a user request, the containers can be taken out of the system by the user. For example, if the system is used within a particular restaurant, the restaurant owner may have their own containers that are used to fulfil user requests. The containers which are moved through the system may be takeaway containers that can be given to the users once their requests are fulfilled. This may be useful because a single container is used to collect the items for a user request and to deliver the collected items to the user. In some cases, the containers may be returned to the owner/operator of the system for reuse. For example, if the system is used in a restaurant or is used to provide food for airplane passengers, the containers may be plates, trays or other receptacles that can be collected after a user/passenger has had their meal, and washed and reused.
provided in the system by an owner/operator of the system, and used to fulfil a user request, but the containers cannot be taken out of the system by the user. For example, the containers may be containers that are kept within the system but are used to collect items to fulfil user requests. When a container contains all the items of a particular user request, the contents of the container may be deposited into a further container that can be removed from the system by the user. The further container may be provided by the owner/operator of the system, or may be provided by a user themselves—the latter may be advantageous because it enables and encourages recycling/reuse of containers. In some cases, the further containers may be returned to the owner/operator of the system for reuse, as explained above.
trays provided in the system by any owner/operator of the system, on which further containers that can be taken out of the system are provided. The further containers may be provided by the owner/operator of the system, or may be provided by a user themselves—the latter may be advantageous because it enables and encourages recycling/reuse of containers. In some cases, the further containers may be returned to the owner/operator of the system for reuse, as explained above.

Each system 100 may be configured depending on which type of container is moved through the system and which container is provided to the user. Thus, the container collection area 104 may be used to collect containers that remain within the system, and/or may be used to collect containers which have been provided by a user, and/or may be used to collect containers which have been returned and washed for reuse. When a user inputs their own container into the container collection area 104, the system may use a mechanism to associate the user request with the user's container. For example, the user may specify, in their user request, the location of their container within the container collection area 104 to associate the container with their user request.

As noted below, each system comprises a request collection area. This is the area in the system 100 from where an operator of the system can collect a completed order/request and provide it to a user, or from where a user can collect their completed order/request themselves.

A system 100 may comprise one or more container collection areas 104, and one or more request collection areas.

The array structure may have one or more tiers. In FIG. 1A, three tiers A, B and C are shown. Multiple stations may be arranged on the tiers A, B, C. The system 100 may, for example, comprise one or more pick-and-place stations 118, and one or more linear weighers 122. In FIGS. 1A and 1B, the pick-and-place stations 118 are provided on tier A, while the linear weighers 122 are provided on tiers B and C.

The system 100 comprises at least one robot 102 capable of selectively engaging, disengaging and moving containers to and from the plurality of stations. In FIG. 1A, a single robot 102 is visible. (FIG. 1B shows part of a second robot 128). The at least one robot 102 may take different forms depending on the process being performed by system 100 and/or the arrangement of the system 100 itself (in particular, the arrangement of the stations). The at least one robot may be, for example, a robotic arm, a cartesian coordinate robot (also known as a three-axis robot), or a collaborative robot (also known as a cobot). It will be understood that this is a non-exhaustive list of example robots and is non-limiting. Where a system 100 comprises more than one robot 102, the robots 102 may be of the same type or different. In FIG. 1A, the robot 102 is a robotic arm which is rotatably mounted at the top of the system 100. The robotic arm 102 is able to collect containers 106 from the container collection area 104, and move the containers 106 between different stations in the system 100. The containers 106 and/or the robotic arm 102 may be designed to or adapted to enable to robotic arm 102 to engage and disengage with the containers 106. In embodiments, the container 106 may be a tray which holds another receptacle, such as a plate or take-away container. This may be useful because the container 106 and/or robotic arm 102 may be adapted to cooperate but no changes need to be made to the receptacle received by a user (e.g. a plate or take-away container for food).

The robotic arm 102 may be instructed to begin the processing for a particular received request and may collect a container 106 from the container collection area 104. The collected container 106 is now associated with that particular received request. The system 100 may comprise a request collection area, where containers 106 may be placed once all the required processes for the request associated with the container have been completed. For example, if a received request is for a salad comprising particular components, the container 106 associated with that received request may be placed into the request collection area when all the components of the salad have been added to the container, such that the request has been completed. The request collection area may be located adjacent to, in the vicinity of, or co-located with the container collection area 104. This may make it easier for a human user 108 to add clean containers 106 to the system 100 and to collect completed containers 106 from the system 100. In embodiments, when the robotic arm 102 adds a completed container 106 to the request collection area, an alert may be transmitted to the human user 108, the customer/user who made the request, or some other operator of the system 100, to indicate that the container 106 is ready to be collected. The alert may be for example a visual alert on the system 100 or may be a visual alert or other communication sent via the system 100 to an external device (e.g. to a user's phone or to a display screen).

As mentioned above, system 100 may comprise one or more pick-and-place stations 118. A pick-and-place station 118 may, in embodiments, comprise a heated container which is able to keep food items at a required temperature. The system 100 may comprise one or more robot arms 112, 114 that are arranged to perform the pick-and-place operation. Each pick-and-place station 118 may have a dedicated robot arm 112, 114, or a group of pick-and-place stations 118 may share a robot arm 112, 114. In FIG. 1A, four adjacent pick-and-place stations 118 share a robot arm 114 or robot arm 112. The robot arm 112/114 is therefore able to move between the four pick-and-place stations 118 when a container 106 is placed by the robotic arm 102 at a particular one of those pick-and-place stations 118. Each pick-and-place station 118 may have a dedicated gripper 120 which is suitable for picking-up the items at that station. In some systems 100, such as food processing systems, dedicated grippers 120 may be also ensure that cross-contamination does not occur between the stations 118. When a container 106 is placed at a pick-and-place station 118 by robotic arm 102, the robot arm 112/114 may be caused to move to the pick-and-place station 118, to engage with the gripper 120 associated with that station 118, and to pick up one or more items from the station 118. Once the one or more items have been deposited into the container 106, the robot arm 112/114 may disengage from the gripper 120.

As mentioned above, the system 100 may comprise one or more linear weighers 122 which are arranged to deposit fixed or variable amounts of particular items. Each linear weigher 122 may be coupled to a hopper, i.e. a storage container used to dispense items via a chute or funnel. The system 100 may comprise one or more computers 124 which may be coupled to and control the linear weighers 122. In embodiments, each linear weigher 122 may be coupled to a dedicated computer 124. In the depicted embodiment, one computer 124 is coupled to and controls four linear weighers 122. The computer 124 may control the amount to be dispensed by the hopper and the dispensing operation itself. The display screen of the computer 124 may be used to communicate data to a human user 110, such as whether the hopper needs to be refilled. It will be understood that display screens and computers 124 may be provided for each station to communicate information to a human user 110. Such information for each station may be used by the system 100 to schedule the processing of received user requests. For example, if a hopper has run out of items to dispense, then the system 100 may schedule the processing of received user requests that don't require those items. Similarly, the information for each station may be used to indicate to human users/operators of the system that more items need to be added to the stations. In a food processing system, this may prompt chefs to cook or prepare items for adding to the stations.

The system 100 may comprise, in some cases, temperature controlled areas or stations. For example, the system 100 may comprise stations which are used to dispense hot food items (e.g. cooked meat) or cold food items (e.g. yoghurt), and therefore, the stations dispensing these items may be temperature controlled. For food safety and hygiene purposes, the temperature controlled areas or stations may comprise temperature sensors to routinely, regularly or continuously monitor the temperature of the station. The temperature controlled areas may comprise other sensors to monitor the environmental conditions around the station. For example, a station may be a fridge or fridge-like station that is used to contain cold/chilled food items such as pots of yoghurt or cartons of milk—a temperature sensor may be used to monitor the temperature within the fridge, but an additional sensor may be used to monitor, for example, how long a door of the fridge was open when a food item was being dispensed. This combination of sensors could be useful because it provides context for why a sudden and sharp increase in the internal temperature of the fridge may be detected, and appropriate action can be taken by the system (e.g. to close the door or to dispose of any food items in the station if the temperature has been above a certain safe temperature for too long).

The system may monitor the stations at all times while the system is operational, using sensors provided within the stations or within the vicinity of the stations. For food safety and hygiene purposes, food quality purposes, and food waste reduction purposes, the system may monitor how long food items have been within a station. For example, some food items may be kept within a station for no more than 1 hour for quality and/or safety/hygiene purposes, while other food items may be kept within a station for up to 4 hours. Thus, food items may have a ‘use by time’ which specifies the maximum amount of time associated with the food items can be within a station before they have to be discarded. A station may be filled with food items at a certain time, and the system monitors whether any food items remain in the station after the associated maximum amount associated with the food items. If food items still remain at this point in time, then the system may determine that fewer food items are required in the station when the station is next replenished, in order to avoid food waste. Furthermore, if food items still remain at this point in time, the food items are discarded and the station and associated dispensers, containers, etc. may be completely cleaned before the station is replenished with new food items. The stations may be cleaned and replenished/refilled while the system is operational, so that the system can continue to complete user requests. Thus, it may be useful to have multiple stations dispensing the same items, and for the stations to be filled with food items and different times, so that there is always at least one station dispensing a particular food item at any given time.

The sensor data and/or the monitoring of each station may be used to determine a status of each station, which may be used to dynamically determine the process schedule to process the plurality of received user requests. The monitoring may be performed using sensors that for example, can sense the quantity or volume of items within a station (e.g. a weight sensor or similar), or using machine vision to visually inspect a station, or using a human operator who manually inspects a station.

FIG. 2A shows a perspective view of a configurable robotic processing system 100 having a single robotic arm 102. Other components of the system 100 have been removed from the image to enable the single robotic arm to be seen. In the image, the robotic arm 102 is shown to be collecting a container 106 from the container collection area 104.

FIG. 2B shows a perspective view of a configurable robotic processing system having a first robotic arm 102 and a second robotic arm 128. The first robotic arm 102 is mounted to the top of the system 100 and the second robotic arm 128 is mounted to the bottom of the system 100. Both robotic arms 102, 128 may be able to collect containers 106 from the container collection area 104, and to place completed containers 106 into a request collection area. The first robotic arm 102 may collect and deposit containers 106 near the top of the system, and the second robotic arm 128 may collect and deposit containers 106 near the bottom of the system, to avoid collisions between the robotic arms. The first robotic arm 102 may be assigned to a first subset of the plurality of stations, and the second robotic arm 128 may be assigned to a second subset of the plurality of stations. The first subset and second subset of the plurality of stations may at least partly overlap.

FIG. 3 shows a perspective view of a configurable robotic processing system 100 having pick-and-place stations 118. Other components of the system 100 have been removed from the image to enable the pick-and-place stations 118 to be seen. One robot arm 114 is also shown. As mentioned above, the pick-and-place stations 118 may be provided on one of the tiers, e.g. tier A, of the system 100 to enable the stations 118 to be reached by the robot arm 114, which may be mounted to the top of the system 100. As explained above, the robot arm 114 may engage with the gripper 120 associated with each station 118 to pick up items from that station.

FIGS. 4A and 4B show perspective views of a configurable robotic processing system having pick-and-place stations 118 and dispense stations 122. Other components of the system 100 have been removed from the image to enable the pick-and-place stations 118 and dispense stations 122 to be seen. The pick-and-place stations 118 may be provided on one of the tiers, e.g. tier A, while the dispense stations 122 may be provided on another tier, e.g. tiers B and C. It will be understood that the pick-and-place stations 118 and dispense stations 122 may be provided on any tier and may be provided on the same tier. The computers 124 used to control the dispense stations (hoppers) 122 are also shown.

Thus far, a curved arrangement of a robotic processing system has been described. Turning now to FIG. 5A, this shows a side view of an example configurable robotic processing system 200 that is arranged in a two-dimensional plane. Specifically, the plurality of stations, the container collection area and request collection are arranged in a two-dimensional plane. This arrangement may be useful if the system is to be located against a wall, for example. The system 200 may comprise one or more stations. In FIG. 5A, two types of station are shown—hoppers/linear weighers 122 and pick-and-place stations 118. It will be understood that both the quantity and types of station, and their arrangement, are exemplary and non-limiting. The stations 122, 118 may be located in areas A′ and B′. The system 200 may comprise a container collection area 104 containing a plurality of containers 106.

FIG. 5B shows a side view of the system 200 of FIG. 5A with the stations and containers removed for clarity. The system 200 may further comprise one or more vertical tracks 202 and/or one or more horizontal tracks 204 provided over the plurality of stations, the container collection area and the request collection area. The system 200 may comprise at least one robot 206, which may be a cartesian coordinate robot (also known as a three-axis robot). In the Figure, two robots 206 are shown. The or each robot 206 may be coupled to and arranged to move along the vertical track(s) 202 and/or horizontal track(s) 204 to enable the robot 206 to move around the system 200 to collect containers 106 and move the containers to different stations.

In embodiments, the system 200 may comprise a first cartesian coordinate robot 206 assigned to a first subset of the plurality of stations, and a second cartesian coordinate robot 206 assigned to a second subset of the plurality of stations. For example, the first cartesian coordinate robot 206 may be assigned to at least area A′ of the system, and the second cartesian coordinate robot 206 may be assigned to at least area B′ of the system, to avoid collisions between the robots 206. The first subset and second subset of the plurality of stations may at least partly overlap.

FIG. 6 shows a flowchart of example steps to control at least one robot to process a request received by a robotic processing system, where the system may comprise a plurality of stations operable in parallel, each station performing an operation, and at least one robot capable of selectively engaging, disengaging and moving containers to and from the plurality of stations. The method may comprise receiving a plurality of user requests, each user request indicating at least one operation to be performed, where the user requests are the same or different. At step S100, the method may comprise determining a process schedule for the at least one robot to process the received plurality of user requests. The method may then comprise controlling, using the determined process schedule, the at least one robot to: collect a container from a container collection area for a first user request that is to be processed (step S102); move the container to a first station of the plurality of stations for a first operation to be performed for that user request (step S104); and move the container, responsive to the determined process schedule, to one or more further stations until the user request is complete (step S106). At step S108, the method may comprise checking if all required operations have been completed for the user request being processed. If the operations have not been completed, the process returns to step S106. If the operations have been completed, the method may comprise checking if there are any further user requests to be processed in the process schedule (step S110). If yes, the method returns to step S102 but now collects a container for the next user request in the process schedule. In other words, the at least one robot collects containers and processes user requests one-by-one until all of the user requests in the process schedule have been completed. If at step S110 it is determined that all the user requests in the process schedule have been completed, the method returns to step S100 to determine a new process schedule for newly received user requests. This may require waiting for new user requests to be received by the system.

FIG. 7 shows a flowchart of example steps to control at least one robot to process, in parallel, multiple requests received by a robotic processing system (such as the robotic processing systems shown in FIGS. 1A to 5B). The method may comprise receiving a plurality of user requests, each user request indicating at least one operation to be performed, where the user requests may be the same or different. At step S200, the method may comprise determining a process schedule for the at least one robot to process the received plurality of user requests. The method may then comprise controlling, using the determined process schedule, the at least one robot to collect a first container from a container collection area for a first user request (step S202) and move the first container to a first station of the plurality of stations for a first operation to be performed (step S204). The method then comprises determining if another container is to be collected (step S206). This may depend on, for example, whether there are any further user requests to process in the process schedule, the capacity of the system at the time, the availability of the required stations for any subsequent user request, whether the first container is ready to be moved to the next station already, etc. If another container is to be collected and there is time for the at least one robot to container to do so, the method comprises instructing the robot to collect another container for another user request in the process schedule (step S208). The method then comprises instructing the robot to move the container to a station as defined in the process schedule for that particular user request (step S210).

The method may comprise checking if there are any further requests in the process schedule to be processed (step S214). If yes, the method returns to step S206 to determine if another container can be collected. If at step S214 it is determined that all the user requests in the process schedule have been completed, the method returns to step S200 to determine a new process schedule for newly received user requests. This may require waiting for new user requests to be received by the system.

At step S206, if another container is not to be collected (e.g. because no new containers are required or because there is no capacity in the system for a new container), then the method may comprise instructing the at least one robot to move one or more containers in the system to the next station or request collection area according to the determined process schedule and requirements for each container/user request (step S212). After performing one or more moves of existing containers, the method may comprise rechecking if another container is to be collected (step S206). In other words, the method shown in FIG. 7 enables the system to process multiple user requests simultaneously, by moving containers around the system and collecting new containers for new requests.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

1. A configurable robotic processing system comprising:
a plurality of stations operable in parallel, each station performing an operation;
at least one robot capable of selectively engaging, disengaging and moving containers to and from the plurality of stations;
a communication module to receive a plurality of user requests, each user request indicating at least one operation to be performed, where the user requests are the same or different;
a controller comprising at least one processor, coupled to the communication module and the at least one robot, to control the at least one robot to:
determine a process schedule for the at least one robot to process the received plurality of user requests; and
control, using the determined process schedule, the at least one robot to:
collect a first container from at least one container collection area for a first user request;
move the first container to a first station of the plurality of stations for a first operation to be performed; and
move the first container, responsive to the determined process schedule, to one or more further stations until the first user request is complete.

2. The system as claimed in claim 1 wherein multiple user requests are processable simultaneously, and wherein the controller is further configured to:
collect, while the first operation or a subsequent operation is being performed for the first user request, another container from the container collection area for at least a second user request;
move the container to another station of the plurality of stations; and
continue moving the first container, second container and any further containers, responsive to the determined process schedule, to one or more further stations until each user request is complete.

3. The system as claimed in claim 1 wherein the step to determine a process schedule for the at least one robot comprises applying a pre-determined process schedule.

4. The system as claimed in claim 1 wherein the step to determine a process schedule for the at least one robot comprises dynamically determining the process schedule based on the received plurality of user requests.

5. The system as claimed in claim 4 wherein dynamically determining the process schedule comprises using at least one of the following: the operations required to complete each of the received user requests, a time taken to complete each of the received user requests, a time taken to complete each operation, an order in which the user requests are received, a number of user requests received in a time period, a status of each station, information on which operations need to be performed before or after other operations for each request, and a delivery time for each received user request.

6. The system as claimed in claim 1 wherein a time taken to complete the operation at each station is the same or different.

7. The system as claimed in claim 1 wherein a container remains at a station until the operation performed by the station is complete and until the determined process schedule causes the at least one robot to collect the container.

8. The system as claimed in claim 1 wherein a time taken to complete the operation at each station is non-deterministic.

9. The system as claimed claim 1 wherein the at least one robot is any one of: a robotic arm, a cartesian coordinate robot, and a collaborative robot or cobot.

10. The system as claimed in claim 1 wherein the at least one robot comprises two or more robots.

11. The system as claimed in claim 10 wherein each robot is assigned to a subset of the plurality of stations.

12. The system as claimed in claim 1 wherein the plurality of stations, the container collection area and a request collection area are arranged in a cylindrical, part-cylindrical, curved or partly-curved array structure having at least one tier.

13. The system as claimed in claim 12 wherein the at least one robot is a robotic arm located along, and rotatable about, the cylindrical axis.

14. The system as claimed in claim 13 wherein the at least one robot comprises a first robotic arm located at a top of the cylindrical array structure that is assigned to a first subset of the plurality of stations, and a second robotic arm located at a bottom of the cylindrical array structure that is assigned to a second subset of the plurality of stations.

15. The system as claimed in claim 1 wherein the plurality of stations, the container collection area and a request collection area are arranged in a two-dimensional plane.

16. The system as claimed in claim 15 further comprising:
at least one track provided over the plurality of stations, the container collection area and the request collection area;
wherein the at least one robot is a cartesian coordinate robot coupled to and arranged to move along the at least one track.

17. The system as claimed in claim 15 wherein the at least one robot comprises a first cartesian coordinate robot assigned to a first subset of the plurality of stations, and a second cartesian coordinate robot assigned to a second subset of the plurality of stations.

18. The system as claimed in claim 1 wherein when the robot moves a container to a station, the controller instructs the station to perform the operation based on the received user request.

19. The system as claimed in claim 1 wherein the step to determine a process schedule for the at least one robot comprises:
determining, using the received user request, an order in which a container needs to be moved to the at least one station.

20. The system as claimed in claim 1 further comprising at least one request collection area, and wherein the controller controls the at least one robot to deposit the first container in the at least one request collection area when the first user request is complete.

21. The system as claimed in claim 20 wherein the controller controls the communication module to output a message indicating that the first user request is complete.

22. The system as claimed in claim 1 wherein the system is a food preparation system, or a mechanical parts selection and packaging system.

23. A method of controlling a configurable robotic processing system comprising a plurality of stations operable in parallel, each station performing an operation, and at least one robot capable of selectively engaging, disengaging and moving containers to and from the plurality of stations, the method comprising:
receiving a plurality of user requests, each user request indicating at least one operation to be performed, where the user requests are the same or different;
determining a process schedule for the at least one robot to process the received plurality of user requests; and
controlling, using the determined process schedule, the at least one robot to:
collect a first container from at least one container collection area for a first user request;
move the first container to a first station of the plurality of stations for a first operation to be performed; and
move the first container, responsive to the determined process schedule, to one or more further stations until the first user request is complete.

24. The method as claimed in claim 23 wherein the step to determine a process schedule comprises dynamically determining the process schedule based on one or both of: the received plurality of user requests, and the time taken for each operation.

25. The method as claimed in claim 23 further comprising:
determining, using the received user request, an order in which a container needs to be moved to the at least one station, and
controlling the at least one robot to move the container to the at least one station in the determined order.

26. The method as claimed in claim 24 further comprising:
determining, for each received user request, the operation to be performed by a station;
determining a required position in the container where the operation is to be performed; and
controlling the at least one robot to position the container at the station to enable the operation to be performed in the required position in the container.

27. (canceled)
